(19) United States
(12) Patent Application Publication
(10) Pub. No.: US 2010/0196856 A1
(43) Pub. Date: Aug. 5, 2010

(54) METHOD OF MAKING AN ORAL PROSTHESIS

(76) Inventor: Noemi Rosalia Mancino, San Nicolas (AR)

Correspondence Address: LUEDEKA, NEELY & GRAHAM, P.C., P O BOX 1871, KNOXVILLE, TN, 37901, US

(21) Appl. No.: 12/362,608

(22) Filed: Jan. 30, 2009

(51) Int. Cl. A61C 13/007

(52) U.S. Cl. 433/201.1

(57) ABSTRACT

A method of rapidly making an oral prosthesis with minimal steps and materials is disclosed. The method generally includes the steps of (1) providing a cast of an oral cavity or portion thereof; (2) applying a setting material along one or more setting zones where teeth are absent from the cast subject's oral cavity; (3) engaging one or more prosthetic teeth with the setting material on the cast; (4) applying a self-curing composition along the outward facing surface(s) of the setting material and a portion of the teeth; (5) removing the setting material; (6) applying a self-curing composition to a portion of the inward facing surface(s) of the teeth and the area where the setting material was located; (6) allowing the self-curing compositions to dry; (7) removing the cured composition and associated teeth (the oral prosthesis) from the cast; and (8) preferably polishing the oral prosthesis.

### FIELD

This disclosure relates to the field of dental prosthetics. More particularly, this disclosure relates to a method of making a customized dental prosthetic in a short period of time.

### BACKGROUND

Oral prostheses have been used for hundreds of years to replace damaged or missing teeth. President George Washington's use of a wooden oral prosthesis is well-known and an often cited trivia notation in history books. Since the time of Washington, many new materials and methods have been developed to make high quality, robust, and relatively comfortable oral prostheses. Unfortunately, even modern techniques for making these products are slow for the face-paced world of the twenty-first century. Even newer methods that use self-curing acrylics in lieu of acrylics or other materials that require high temperature drying and other time and energy consuming steps still, nonetheless, have significant drawbacks.

What is needed, therefore, is a method of making oral prostheses more efficiently. More specifically, what is needed is a method of making oral prostheses in which substantially all of the steps may be accomplished by hand.

### SUMMARY

The above and other needs are met by a method of rapidly making an oral prosthesis using a cast of at least an upper or lower section within a mouth cavity including any exposed teeth and adjacent gums. The method includes the steps of (a) applying a first setting material along the cast in a first zone; (b) engaging a first prosthetic tooth with the setting material along the first zone; (c) applying a first self-curing composition along a first exposed edge portion of the first prosthetic tooth and an adjacent first setting material surface; (d) removing the first setting material by applying a heated fluid along a second exposed edge portion of the first prosthetic tooth; and (e) applying a second self-curing composition along the second exposed edge portion of the first prosthetic tooth and an adjacent first filling region including at least part of the space formerly occupied by the first setting material prior to removal thereof. The heated fluid is preferably air, nitrogen, carbon dioxide, water, or a combination thereof. In a preferred embodiment, the first setting material consisting essentially of wax. In a related embodiment, the first setting material comprising at least over fifty percent wax by weight.

In a related embodiment, the method also includes an initial step of applying a removal aid to at least a portion of the cast to facilitate the eventual removal of the oral prosthesis from the cast.

In another related embodiment, step (c) of the method further includes the step of aligning an upper section of the cast and a lower section of the cast in a simulated occluded position to determine how well the first tooth fits with the remainder of the oral prosthesis.

In yet another embodiment, step (d) further includes allowing the first self-curing composition to harden for a time period ranging from about one minute to about twenty minutes. In a related embodiment, step (f) further includes drying the oral prosthesis for a time period ranging from about one hour to about three hours. In a very similar embodiment, step (f) includes drying the oral prosthesis for at least about two hours.

In one embodiment, the method described above further includes the steps of (g) applying a second setting material along the cast in a second zone; (h) engaging a second prosthetic tooth with the second setting material along the second zone; (i) applying a third self-curing composition along a third exposed edge portion of the second prosthetic tooth and an adjacent second setting material surface; (j) removing the second setting material by applying a heated fluid along a fourth exposed edge portion of the second prosthetic tooth; and (k) applying a fourth self-curing composition along the fourth exposed edge portion of the second prosthetic tooth and an adjacent second filling region including at least part of the space formerly occupied by the second setting material prior to removal thereof.

In the embodiments above with steps (a)-(e) and/or steps (g)-(k), a related embodiment further includes the step of applying a fifth self-curing composition along a first section of the cast configured as at least a portion of the hard palate of a mouth, wherein the fifth self-curing composition along the first section of the cast partially overlaps with the second self-curing composition and the fourth self-curing composition. Alternatively or additionally, another embodiment includes the step of applying a fifth self-curing composition along a first section of the cast configured as at least a portion of the substantially U-shaped area under the tongue and that extends about the frenulum lingua of a mouth, wherein the fifth self-curing composition along the first section of the cast partially overlaps with the second self-curing composition and the fourth self-curing composition. A related embodiment includes an additional step of drying the oral prosthesis for at least one hour during which time the fifth self-curing composition along the first section of the cast adheres to the second self-curing composition and the fourth self-curing composition.

In another embodiment, the method described above including steps (a)-(f) further includes the steps of (g) removing the oral prosthesis from the cast; and (h) polishing the oral prosthesis. In a related embodiment, the polishing step further includes the steps of (h)(1) polishing the oral prosthesis using a cone stone; (h)(2) polishing the oral prosthesis using a fine sanding tool; and (h)(3) buffing the oral prosthesis using a felt cone, pumice powder, and water. In another embodiment, the polishing step further includes the step of marking each prosthetic tooth.

In a preferred embodiment, the first self-curing composition comprises a substance derived from acrylic acid and wherein the second self-curing composition comprises a substance derived from acrylic acid. In another preferred embodiment, the first self-curing composition comprises acrylic acid and wherein the second self-curing composition comprises acrylic acid.

In a preferred embodiment, the first self-curing composition, the second self-curing composition, the third self-curing composition, the fourth self-curing composition, and the fifth self-curing composition are substantially the same substance. Similarly, in another preferred embodiment, the first setting material and the second setting material are substantially the same.

An advantage of some of the embodiments described herein include oral prostheses of substantial strength and quality may be made in a matter of a few hours as opposed to days; substantially all of the steps may be performed by hand using hand tools; and the efficiency and convenience of the embodiments described herein allow for oral prostheses to be made in remote areas (e.g., areas with no electricity). An important feature described in this disclosure is the engagement of prosthetic teeth with a temporary setting material so as to hold such teeth firmly in a stationary position until curing material has been added and cured so as to take over the anchoring role. Moreover, the setting material (preferably wax or a wax-based material) is only applied to contact areas (“zones”) where teeth are desired to be replaced, thereby minimizing the amount of setting material required. Another advantage is that one or multiple teeth may be engaged with the setting material in one general step.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a cast of an upper portion of a human's upper oral cavity and a removal aid being applied thereto;

FIG. 2 shows the cast of FIG. 1 and further shows setting material applied to two separate locations where teeth are absent along the cast;

FIG. 3 shows the cast of FIG. 2 after some prosthetic teeth have been engaged with the setting material;

FIG. 4 shows the cast of FIG. 3 and further shows a self-curing composition layer(s) that has been applied along the outward facing surface(s) of the setting material and portions of the prosthetic teeth;

FIG. 5 shows the cast of FIG. 4 being held in an occluded position;

FIG. 6 shows the application of a fluid to the inward facing surface(s) of the setting material of the cast of FIG. 4 so as to substantially remove the setting material;

FIG. 7 shows the cast of FIG. 6 after substantial removal of the setting material and during the application of a self-curing composition to the inward surface(s) and area(s) where the setting material formerly was located;

FIG. 8 shows the application of a self-curing material to the cast of FIG. 7 along the area where the hard pallet of a human oral cavity is typically located;

FIG. 9 shows the application of a self-curing material to the cast of FIG. 7 along the area where the hard pallet of a human oral cavity is typically located;

FIG. 10 shows an oral prosthesis, including the applied self-curing composition(s) and the prosthetic teeth, situated on the cast from FIGS. 8-9;

FIG. 11 shows the oral prosthesis of FIG. 10 being carefully removed from the cast of FIG. 10 using a sharp-edged tool;

FIG. 12 shows the oral prosthesis of FIG. 10 after it has been separated from the cast of FIG. 10;

FIG. 13 shows the oral prosthesis of FIG. 12 being polished using a rotational tool and a conically-shaped polishing stone attached thereto;

FIG. 14 shows the oral prosthesis of FIG. 13 being marked by a bit being rotated by a rotational tool;

FIG. 15 shows the oral prosthesis of FIG. 14 being polished using a rotational tool and a sanding tool attached thereto;

FIG. 16 shows the oral prosthesis of FIG. 15 being buffed using a rotational tool and a felt tool attached thereto; and

FIG. 17 shows the oral prosthesis of FIG. 16 after substantially all manufacturing steps are completed.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense).
Cast: any substantially solid and robust structure used to mimic internal portions of a mouth including gum(s) and/or teeth; preferably a plaster cast formed by methods known to persons having ordinary skill in the art.
Prosthetic Tooth: any type of prosthetic tooth known to a person having ordinary skill in the art including a non-human tooth.
Self-Curing Composition: any autopolymerizable composition (typically a resin) that cures in substantially standard temperature and pressure conditions with or without light and that may be used as a substantial part of a dental prosthesis upon curing (preferably polymerized acrylates).
Removal Aid: any substance useful for facilitating the removal of a self-curing composition from a cast (e.g., a substance to help separate substantially cured acrylate polymer from plaster).
Wax: any of a group of substances including hydrocarbons, alcohols, fatty acids, and/or esters that remain in a moldable solid form at substantially standard temperature and pressure but which liquefy at temperatures at or greater than about 40° C.

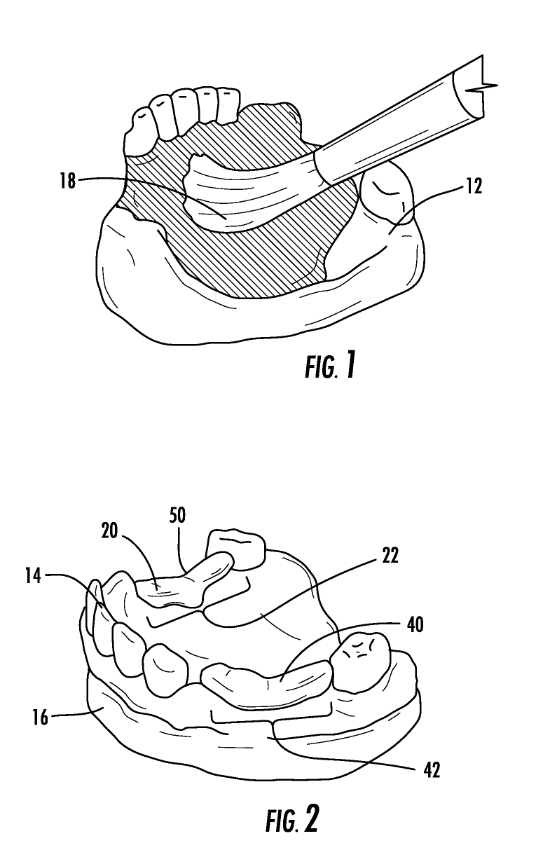

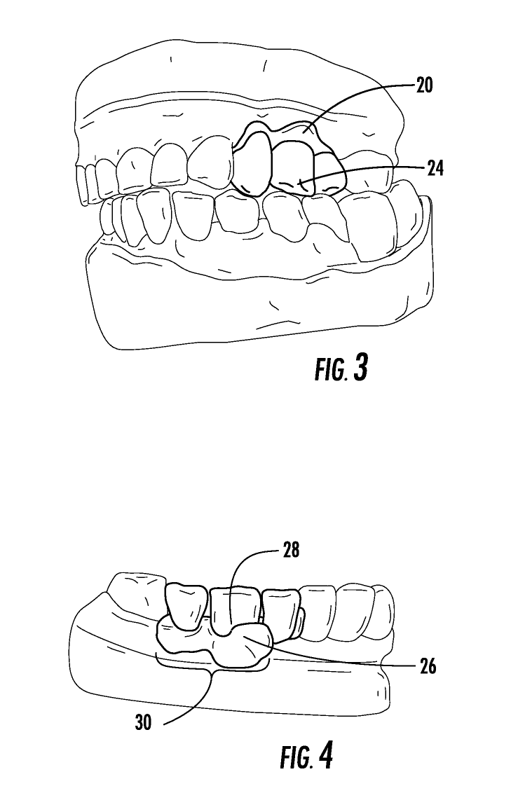

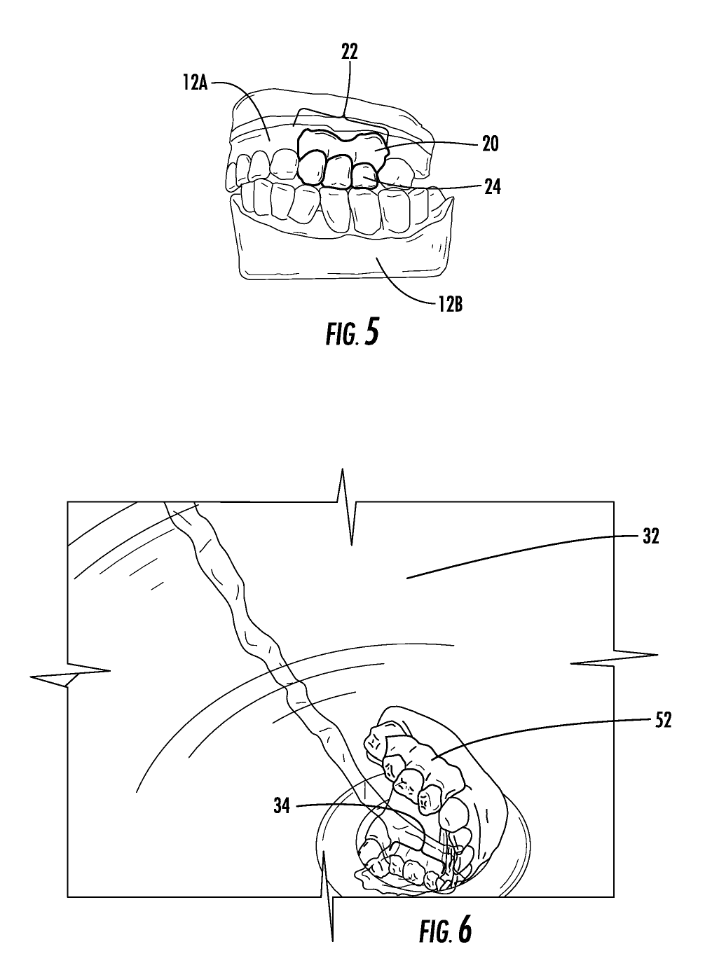

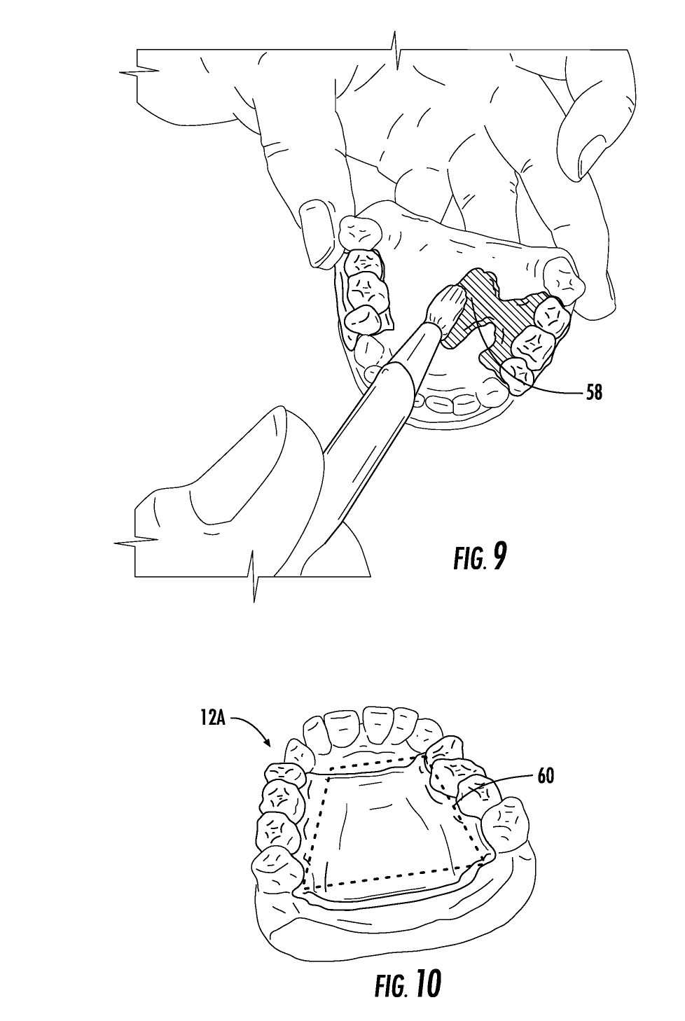

FIGS. 1-17 depict an embodiment of a method of rapidly making an oral prosthesis 10 using a cast 12 of at least an upper or lower section within a mouth cavity including any exposed teeth 14 and adjacent gums 16. Preferably, an initial step (Step 110) includes applying a removal aid 18 to at least a portion of the cast 12 to facilitate the eventual removal of the oral prosthesis 10 from the cast 12 as shown in FIG. 1. A first setting material 20 is then applied (Step 112) along the cast 12 in a first zone 22 as shown in FIG. 2. The first zone 22 preferably includes an area where one or more teeth are missing in the cast. One or more first prosthetic teeth 24 are then engaged (Step 114) with the first setting material 20 along the first zone 22 as shown in FIG. 3. FIG. 4 shows a following step (Step 116) which includes applying a first self-curing composition 26 along a first exposed edge portion 28 of the first prosthetic teeth 24 and an adjacent first setting material surface 30. At this point, if the cast 12 includes an upper section 12A and a lower section 12B, the upper section of the cast 12A and the lower section of the cast 12B are aligned (Step 118) in a simulated occluded position to determine how well the first prosthetic teeth 24 fits with the remainder of the oral prosthesis 10. This aligning step may be done by hand as shown in FIG. 5.

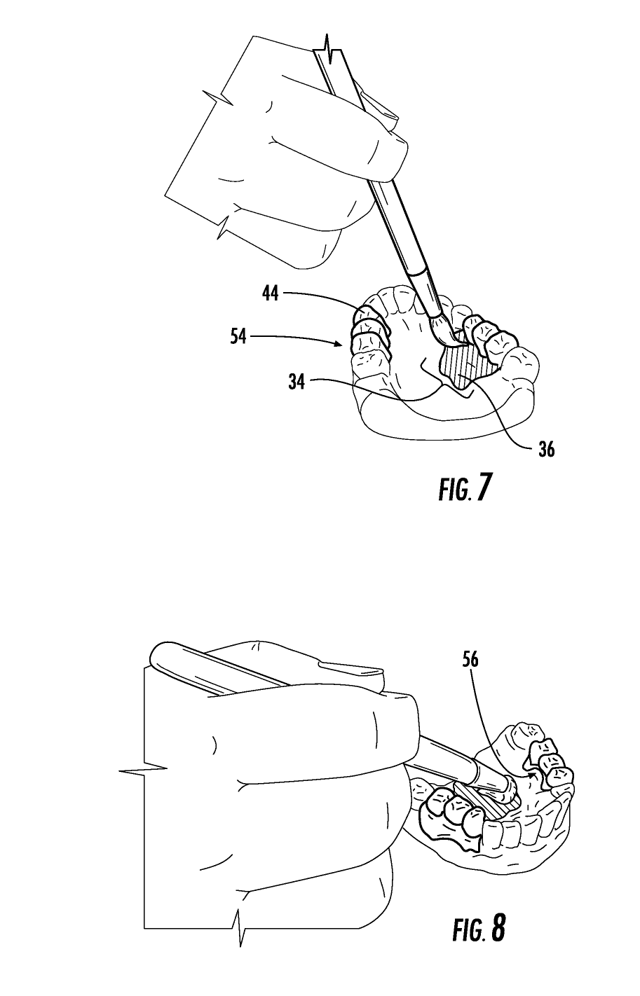

If the aligning step reveals acceptable occlusion results, the first setting material 20 is then removed (Step 120) by applying a heated fluid 32 along a second exposed edge portion 34 of the first prosthetic teeth 24 as shown in FIG. 6. After the first setting material 20 is substantially removed, a second self-curing composition 36 is applied (Step 122) along the second exposed edge portion 34 of the first prosthetic teeth 24 and an adjacent first filling region 38 including at least part of the space formerly occupied by the first setting material 20 prior to removal thereof as shown in FIG. 7.

Preferably, Step 116 further includes allowing the first self-curing composition 26 to harden (i.e., initially cure) for a time period ranging from about one minute to about twenty minutes, most preferably about two minutes. After the second self-curing composition 36 is applied in Step 122, the first self-curing composition 26 and the second self-curing composition 36 are allowed to cure (Step 124) as the oral prosthesis is dried for about one hour to about three hours. In a preferred embodiment, the first self-curing composition 26 and the second self-curing composition 36 are allowed to cure for at least about two hours and most preferably for about two hours. The drying/curing steps are preferably accomplished by passive air drying under the conditions of from about 90 kPa to about 110 kPa and from about 20° C. to about 30° C. The heated fluid 32 used in Step 120 is preferably air, nitrogen, carbon dioxide, water, or a combination thereof. The first setting material 20 is preferably wax or a mixture including at least fifty percent wax by weight. The first self-curing composition 26 is preferably a substance derived from acrylate monomers such as, for example, propenoic acid, and may be formed, for example, by mixing an alcohol with the acrylate monomer. The first self-curing composition 26 may also be formed by mixing, for example, an acrylate resin with a catalyst (but no additional heat or pressure) so that the resin undergoes polymerization. Other self-curing resins and methods for catalyzing such resins are contemplated by this disclosure and are known to persons having ordinary skill in the art. Examples of compositions that may be used as the first self-curing composition include Palapress Vario® available from Heraeus Kulzer, Inc. of Hanau, Germany and Orthoresin™ available from DeguDent of Hanau, Germany. An example of compositions that me be used as the removal aid 18 include Aislar® separating fluid available from Heraeus Kulzer, Inc. of Hanau, Germany and Separating Fluid available from Ivoclar Vivadent AG of Schaan, Liechtenstein.

In the example shown in FIGS. 1-8, there are two spaces where teeth are missing. In other situations, however, many more teeth may be missing (perhaps all teeth) or maybe only one tooth will be missing. This disclosure contemplates all of these scenarios. To continue with the example shown in FIGS. 1-8, an additional step of applying (Step 126) a second setting material 40 along the cast 12 in a second zone 42. One or more prosthetic teeth 44 may then be engaged (Step 128) with the second setting material 40 along the second zone 42. A third self-curing composition 46 may then be applied (Step 130) along a third exposed edge portion 48 of the second prosthetic teeth 44 and an adjacent second setting material surface 50. The second setting material 40 may then be removed (Step 132) as in Step 120 above. Then a fourth self-curing composition 52 is applied (Step 134) along a fourth exposed edge portion 54 of the second prosthetic teeth 44 and an adjacent filling region 56 including at least part of the space formerly occupied by the second setting material 40 prior to removal thereof.

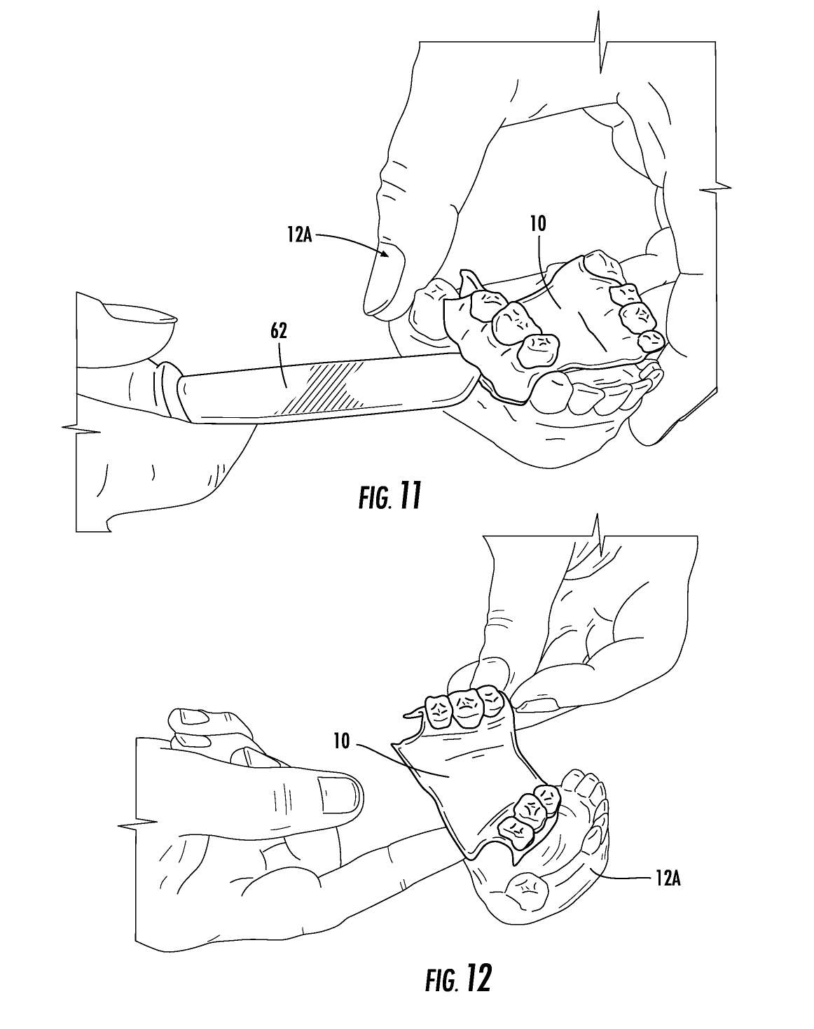

Although Steps 126 through 134 may be performed in sequence after Steps 112 through 124, it should be apparent that these separate sets of steps may also be performed in parallel as shown in FIGS. 1-8. For example, Step 112 and Step 126 may be accomplished together as one step. The same is true for Steps 114 and 128, Steps 116 and 130, Steps 120 and 132, and Steps 122 and 134. Regardless of whether such steps are performed in parallel or in sequence, other steps may be involved such as bridging the gap between prosthetic structures shown in FIGS. 9-10 so as to create a single prosthetic structure.

To this end, the embodiment shown in FIGS. 1-8 may further include a step of applying (Step 136) a fifth self-curing composition 58 along a first section 60 of the cast 12A configured as at least a portion of the hard palate of a mouth, wherein the fifth self-curing composition 58 along the first section 60 of the cast 12A partially overlaps with the second self-curing composition 36 and the fourth self-curing composition 52. By overlapping, these self-curing compositions may cure together (Step 138) as a single hardened structure as shown in FIG. 9. In a situation in which the lower section of a mouth (i.e., the lower section of the cast 12B) is involved, the fifth self-curing composition 58 would be applied on the U-shaped area around the tongue that extends about the frenulum lingua such that self-curing compositions overlap and cure as a single hardened structure. The time period for curing is at least about one hour, preferably at least about two hours, sometimes ranging from about one hour to about three hours, and most preferably about two hours. Preferably, the first self-curing composition 26, the second self-curing composition 36, the third self-curing composition 46, the fourth self-curing composition 52, and the fifth self-curing composition 58 are all made of substantially the same material(s). Similarly, the first setting material 20 and the second setting material 40 are preferably made of substantially the same material(s).

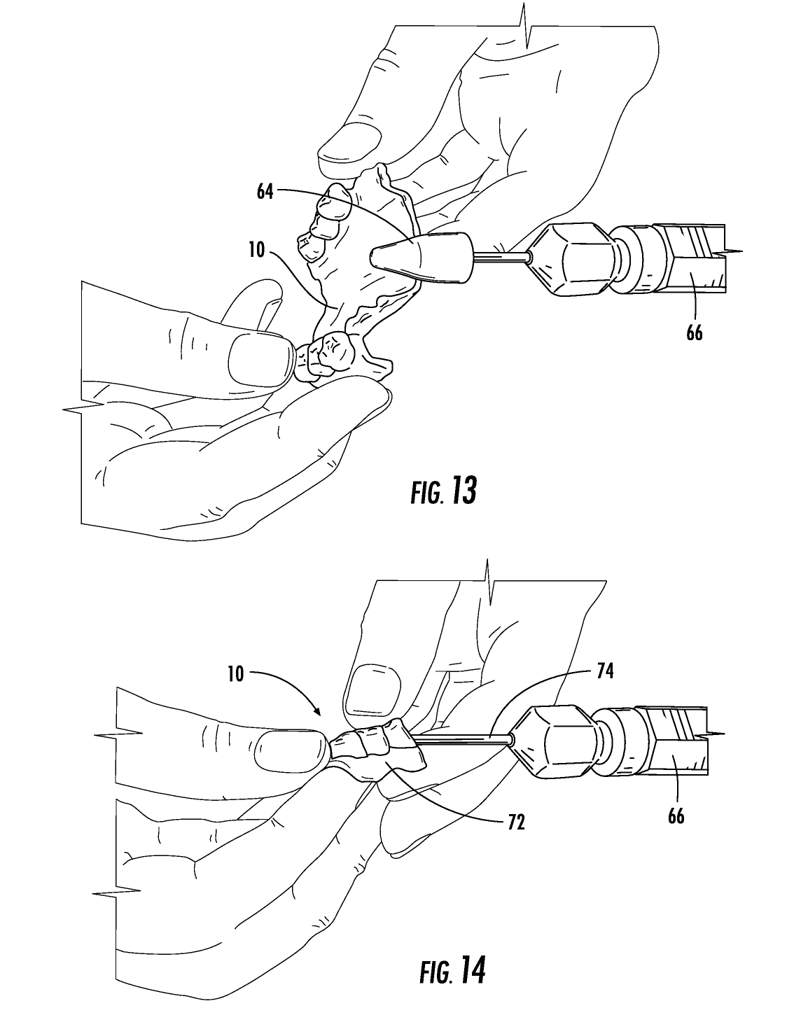

After one or more curing steps as described above (e.g., Step 138), the oral prosthesis 10 is preferably removed (Step 140) from the cast 12 as shown in FIGS. 11-12. Removal of the oral prosthesis 10 is preferably accomplished using a sharp instrument 62 to carefully and subtly create small spaces between the oral prosthesis 10 and the cast 12 at multiple locations until the oral prosthesis 10 may be lifted from the cast 12 with little or no structural impairment to the oral prosthesis 10.

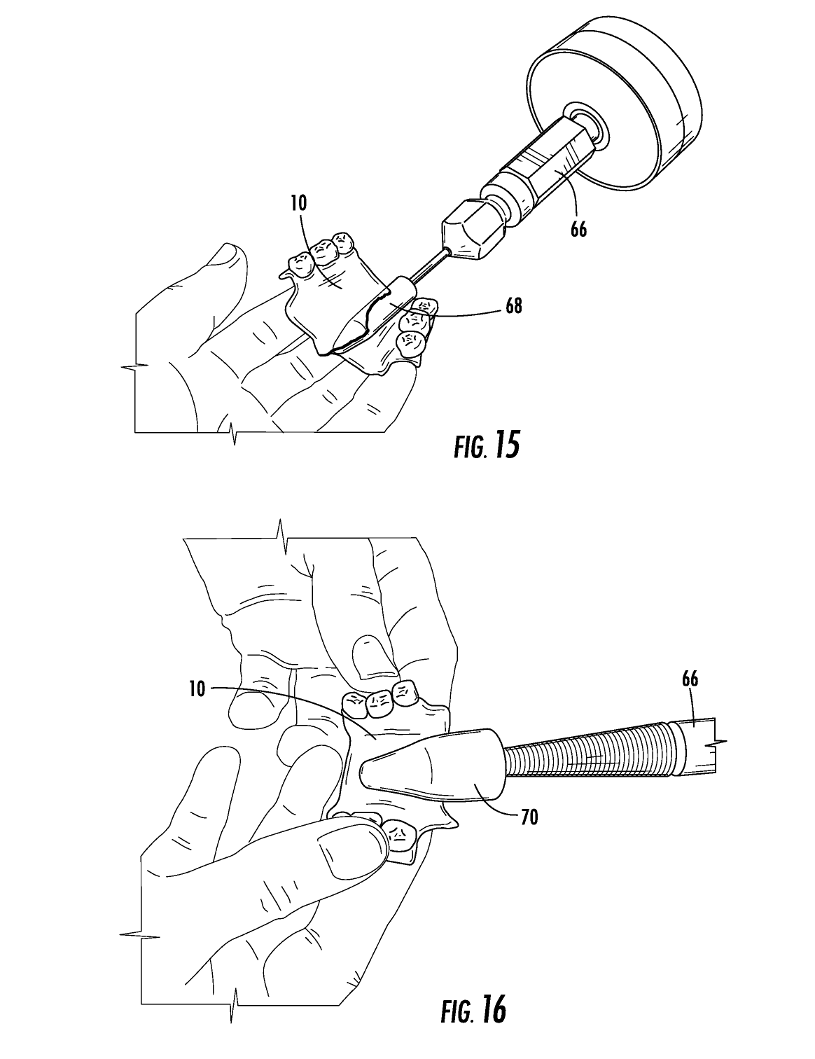

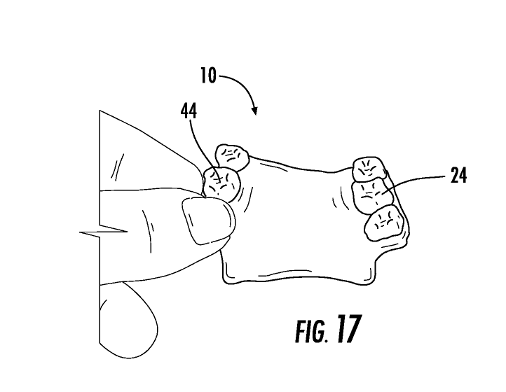

After the oral prosthesis 10 is removed from the cast 12, a polishing step (Step 142) is preferably used to smooth the surfaces of the oral prosthesis 10. The polishing step is preferably sub-divided into multiple refining steps including (Step 142A) polishing with a cone stone 64 and an associated rotational tool 66 as shown in FIG. 13, (Step 142B) polishing with a sanding tool 68 as shown in FIG. 15, and (Step 142C) buffing with a felt cone 70 as shown in FIG. 16. Before the polishing step is concluded, the prosthetic teeth (24, 44) are preferably marked to indicate the separation between the prosthetic teeth (24, 44) and a prosthetic gum portion 72 of the oral prosthesis 10 using, for example, the rotational tool 66 and an associated bit 74 as shown in FIG. 14.

It is common for oral prostheses to fit a patient improperly after initial production. For this reason, many conventional methods build in or otherwise attach extensions or hook-like structures to better conform an oral prosthesis to a patient's mouth. These steps are undesirable, however, and are best avoided. Embodiments of the method described herein avoid the drawback of such extensions by relining (Step 144) the oral prosthesis 10 with the self-curing composition(s) (26, 36, 46, 52, 58) as many times as necessary to ensure a snug and comfortable fit. These one or more re-fitting steps may be accomplished rapidly because, among other things, the rapid curing rate of the self-curing composition(s) (26, 36, 46, 52, 58) at standard room temperature and pressure.

Various embodiments of the method described in this disclosure may be used to make oral prostheses such as, for example, dentures. Certain embodiments may be used to make an oral prosthesis for a patient missing one tooth or as many as all teeth. Therefore, the application for the method described herein is broad and may also be utilized in veterinary medicine for other animals other than humans.

The previously described embodiments of the present disclosure have many advantages, including the short amount of time required to make an oral prosthesis, the simplicity of the process, and the strength of the final product. With regard to time, an oral prosthesis for replacing an entire set of teeth requires about two and one-half hours to complete using the method described herein. Virtually all of the steps required to use the method described herein may be performed by hand.

The method described herein is preferable to prior art methods because of its simplicity and efficiency. For example, wax is only placed in areas where prosthetic teeth and self-curing composition(s) are to be applied. No muffle furnace or extra steps associated with a muffle furnace as taught in the conventional art are necessary for curing the self-curing composition(s) as described herein. Such steps in the prior art using muffles required significant time and repetitive pressurizing, refilling, cutting, and boiling steps to obtain a finalized product. Yet, prostheses made from the method described herein are just as durable and strong as prosthesis made from methods requiring a muffle and/or high pressurization steps. Moreover, when a prosthesis is removed from a muffle as is the case with conventional methods, there is a significant amount of residue of, for example, cured acrylic and plaster that must be scraped off of the prosthesis prior to polishing. Also, many conventional methods of making oral prostheses results in products that require hooks or other extensions used to hold oral prostheses to a patient's teeth. These extensions—often metallic—are uncomfortable and have been linked to the accelerated development of cavities. Such drawbacks are avoided by products made using embodiments of the method described herein.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A method of rapidly making an oral prosthesis using a cast of at least an upper or lower section within a mouth cavity including any exposed teeth and adjacent gums, the method comprising the steps of:
a. applying a first setting material along the cast in a first zone;
b. engaging a first prosthetic tooth with the setting material along the first zone;
c. applying a first self-curing composition along a first exposed edge portion of the first prosthetic tooth and an adjacent first setting material surface;
d. removing the first setting material by applying a heated fluid along a second exposed edge portion of the first prosthetic tooth; and
e. applying a second self-curing composition along the second exposed edge portion of the first prosthetic tooth and an adjacent first filling region including at least part of the space formerly occupied by the first setting material prior to removal thereof.

2. The method of claim 1 further comprising an initial step of applying a removal aid to at least a portion of the cast to facilitate the eventual removal of the oral prosthesis from the cast.

3. The method of claim 1 wherein step (c) further comprises the step of aligning an upper section of the cast and a lower section of the cast in a simulated occluded position to determine how well the first tooth fits with the remainder of the oral prosthesis.

4. The method of claim 1 wherein step (d) further comprises allowing the first self-curing composition to harden for a time period ranging from about three minutes to about twenty minutes.

5. The method of claim 1 wherein step (f) further comprises drying the oral prosthesis for a time period ranging from about one hour to about three hours.

6. The method of claim 5 wherein step (f) comprises drying the oral prosthesis for at least about two hours.

7. The method of claim 1 wherein the heated fluid is a substance selected from the group consisting of air, nitrogen, carbon dioxide, water, and combinations thereof.

8. The method of claim 1 further comprising the steps of:
g. applying a second setting material along the cast in a second zone;
h. engaging a second prosthetic tooth with the second setting material along the second zone;
i. applying a third self-curing composition along a third exposed edge portion of the second prosthetic tooth and an adjacent second setting material surface;
j. removing the second setting material by applying a heated fluid along a fourth exposed edge portion of the second prosthetic tooth; and
k. applying a fourth self-curing composition along the fourth exposed edge portion of the second prosthetic tooth and an adjacent second filling region including at least part of the space formerly occupied by the second setting material prior to removal thereof.

9. The method of claim 8 further comprising the step of (l) applying a fifth self-curing composition along a first section of the cast configured as at least a portion of the hard palate of a mouth, wherein the fifth self-curing composition along the first section of the cast partially overlaps with the second self-curing composition and the fourth self-curing composition.

10. The method of claim 9 further comprising the step of (m) drying the oral prosthesis for at least one hour during which time the fifth self-curing composition along the first section of the cast adheres to the second self-curing composition and the fourth self-curing composition.

11. The method of claim 8 further comprising the step of (l) applying a fifth self-curing composition along a first section of the cast configured as at least a portion of the substantially U-shaped area under the tongue and that extends about the frenulum lingua of a mouth, wherein the fifth self-curing composition along the first section of the cast partially overlaps with the second self-curing composition and the fourth self-curing composition.

12. An oral prosthesis made using the method of claim 1 wherein the first self-curing composition comprises a substance derived from acrylic acid and wherein the second self-curing composition comprises a substance derived from acrylic acid.

13. An oral prosthesis made using the method of claim 1 wherein the first self-curing composition comprises acrylic acid and wherein the second self-curing composition comprises acrylic acid.

14. An oral prosthesis made using the method of claim 9 wherein the first self-curing composition, the second self-curing composition, the third self-curing composition, the fourth self-curing composition, and the fifth self-curing composition are substantially the same substance.

15. An oral prosthesis made using the method of claim 1, the first setting material consisting essentially of wax.

16. An oral prosthesis made using the method of claim 1, the first setting material comprising at least over fifty percent wax by weight.

17. An oral prosthesis made using the method of claim 8 wherein the first setting material and the second setting material are substantially the same.

18. The method of claim 4 further comprising the steps of:
g. removing the oral prosthesis from the cast; and
h. polishing the oral prosthesis.

19. The method of claim 18 wherein the polishing step (h) further comprises the steps of:
(h)(1). polishing the oral prosthesis using a cone stone;
(h)(2). polishing the oral prosthesis using a fine sanding tool; and
(h)(3). buffing the oral prosthesis using a felt cone, pumice powder, and water.

20. The method of claim 18 wherein the polishing step (h) further comprises the step of marking each tooth.
